(19) United States
(12) Patent Application Publication
(10) Pub. No.: US 2002/0083342 A1
(43) Pub. Date: Jun. 27, 2002

(54) Systems, methods and computer program products for accessing devices on private networks via clients on a public network

(76) Inventors: Brian T. Webb, Raleigh, NC (US); Gregory T. Knowles, Raleigh, NC (US)

Correspondence Address: MYERS BIGEL SIBLEY & SAJOVEC, PO BOX 37428, RALEIGH, NC, 27627, US

(21) Appl. No.: 09/874,802

(22) Filed: Jun. 5, 2001

Related U.S. Application Data
(60) Provisional application No. 60/257,240, filed on Dec. 21, 2000.

(51) Int. Cl. G06F 15/16

(52) U.S. Cl. 713/201; 709/217

(57) ABSTRACT

Systems, methods, and computer program products that can allow users to access one or more devices on a private network, via clients on a public network, are provided. A gateway on a private network accepts a user log-in request from a client on a public network. The rights of the user to access one or more devices on the private network are ascertained and the gateway serves a Web page to the client that identifies each device on the private network for which the user has access rights. Upon receiving a request from the client to access a Web server of a device on a private network, the gateway redirects the received client request to the Web server. The gateway is configured to “scrub” a Web page served by a device Web server to remove any links to Web servers of devices for which the user does not have access rights and to modify a uniform resource locator (URL) containing an address not valid on the public network with an address that is valid on the public network.

### RELATED APPLICATIONS

This application claims the benefit of U.S. Provisional Application No. 60/257,240 filed Dec. 21, 2000, the disclosure of which is incorporated herein by reference in its entirety as if set forth fully herein.

### FIELD OF THE INVENTION

The present invention relates generally to computer networks and, more particularly, to systems, methods and computer program products for accessing devices connected to computer networks.

### BACKGROUND OF THE INVENTION

Increasingly, existing homes and homes under construction are being “networked” wherein communications cables (video, data, and/or telecommunications cables) are being extended to many rooms and, in some cases, to multiple locations within each room. The benefits of “home networking” may include the ability to network multiple computers, printers and peripheral devices throughout a home and to access the Internet through a single high-speed connection; to use a digital phone system, such as an ISDN line, throughout the home; to add security video cameras in the home and view them on any television; and/or to add future equipment that may allow a homeowner to use the same hand-held remote control in any room.

Home networks are increasingly being used to network “smart” devices such as stereos, kitchen appliances, energy management systems, and security systems. Many of these smart devices are administered via small on-board Web servers. For example, to configure a printer connected to a home network, a user can remotely access the printer's on-board Web server via a Web browser. Moreover, homeowners can adjust the heat or air-conditioning in a room from a PC, watch a security-camera feed of their home over a Web browser, or distribute audio or video throughout the home.

With the current proliferation of high-speed Internet access, the ability and desire to access smart devices from remote locations via the Internet is increasing, also. Some popular device-to-Internet applications currently include energy measurement and load management in the home; home security systems that a home owner can monitor and control away from home; continuous monitoring of critical care and home-care patients; and/or predictive failure reporting for home appliances.

Currently, devices are networked in the home via technologies such as, Ethernet, wireless, phone-line networking, and power-line networking. Phone-line networking allows PCs and other devices to be networked by plugging them into phone jacks, while power-line networking allows PCs and other devices to communicate through electrical outlets. Regardless of the network technology utilized, home networks conventionally utilize a “residential gateway”, which is an application server executing on a device connected to the home network, to connect networked devices to the Internet. Residential gateways typically include various security features, such as firewalls to prevent strangers from hacking into home networks, as well as virus protection. OSGi (Open Service Gateway Initiative) is an exemplary residential gateway standard for connecting devices, such as home appliances and security systems, to the Internet so that these devices can be managed remotely and interactively.

Unfortunately, it may be difficult to remotely access a device on a home network unless the user knows the physical address (i.e., the IP address) of the device. Moreover, it may be difficult, if not impossible, to know the IP address for devices on a home network that utilizes DHCP (Dynamic Host Configuration Protocol) since DHCP causes the address of a device to change constantly. In addition, if a home network is protected by a firewall, remote access of devices on the network from the Internet may not be possible. Even if remote access of devices on a home network is possible, security issues are of utmost importance since it is desirable to reduce the likelihood of unauthorized access by others.

### SUMMARY OF THE INVENTION

In view of the above discussion, systems, methods, and computer program products that can allow users to access one or more devices on a private network via a client on a public network, are provided. Various private network devices include Web servers having an IP address that is valid on the private network but is not valid on the public network. A gateway connected to the private network is configured to accept user log-in requests from users via clients on the public network. The gateway then ascertains the rights of the user to access devices on the private network.

The gateway serves a Web page to the client that identifies each device on the private network for which the user has access rights. The Web page preferably includes a link to a Web server of a device on the private network for which the user has access rights. A link to a Web server preferably includes a uniform resource locator (URL) for the gateway that is valid on the public network and an identification of a gateway port that is mapped to the respective Web server on the private network.

Upon receiving a request from a client to access a Web server of a device, the gateway redirects the received client request to the Web server. The gateway is configured to “scrub” a Web page served by a device Web server in response to a client request to remove any links to Web servers of devices for which the user does not have access rights. In addition, the gateway may be configured to scrub a Web page to modify a uniform resource locator (URL) containing an address not valid on the public network with an address that is valid on the public network. Web page scrubbing preferably includes replacing an address valid only on the private network with a URL for the gateway that is valid on the public network and an identification of a gateway port that is mapped to the replaced address. Scrubbed web pages are then served to a requesting user client.

Embodiments of the present invention can allow remotely located users to securely access devices on a private network via the Internet, even when IP addresses of the devices are not valid on the Internet, and/or are not known to the user.

Because security is a concern, embodiments of the present invention preferably utilize one or more security protocols (e.g., Secure Sockets Layer) for user connections. In addition, user authentication at login are also preferably utilized. Preferably, users will not have access to devices on a private network until he or she is authenticated. Moreover, Web page and/or device access may be limited based on a user's login authentication.

One or more levels of users and/or user groups may be provided. For example, users who are part of an administrator group may be given administrator privileges. Users who are part of the other group will be given access to one or more devices on a private network, but will not be given the ability to perform administrator functions. For example, a “parents” group may have access to all lights and audio devices in the house, but the “children's” group may only have access to lights and audio devices in their room. Similarly, users in the “appliance repair” group may only have access to a specific appliance within a house.

According to other embodiments of the present invention, the ability to “discover” devices on a private network may be provided. For example, a private network can be “scanned” or “crawled” to find devices that publish Web pages.

### BRIEF DESCRIPTION OF THE DRAWINGS

FIG. 1 is a schematic diagram of a private network having various devices connected thereto including a gateway, and a client on a public network that is communicating with one or more of the devices on the private network via the gateway, according to embodiments of the present invention.

FIG. 2 is an exemplary routing list of addresses and open ports of a Web server for devices connected to the private network of FIG. 1 that have been mapped by the gateway of FIG. 1 responsive to user requests.

FIG. 3 illustrates exemplary operations for discovering device Web servers on a private network, according to embodiments of the present invention.

FIG. 4 illustrates exemplary operations for accessing one or more devices on a private network via a client on a public network, according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout the description of the drawings.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including, but not limited to, hard disks, CD-ROMs, optical storage devices, and magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, or in various other programming languages. Software embodiments of the present invention do not depend on implementation with a particular programming language.

In addition, portions of computer program code may execute entirely on one or more data processing systems. For example, program code for carrying out aspects of the present invention may execute entirely on a server, or may execute partly on a server and partly on a client within a client device (i.e., a user's Web client), or as a proxy server at an intermediate point in a communications network. In the latter scenario, a client device may be connected to a server through a LAN or a WAN (e.g., an intranet), or the connection may be made through the Internet (e.g., via an Internet Service Provider).

The present invention is described below with reference to block diagram and/or flowchart illustrations of methods, apparatus (systems) and computer program products according to embodiments of the invention. It is understood that each block of the block diagram and/or flowchart illustrations, and combinations of blocks in the block diagram and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

The Internet and Intranets

As is known to those of skill in the art, the Internet is a worldwide decentralized network of computers having the ability to communicate with each other. The World-Wide Web (Web) is comprised of server-hosting computers (Web servers) connected to the Internet that serve hypertext documents (referred to as Web pages). Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), as well as image formats such as Graphics Interchange Format (GIF) and Joint Photographic Experts Group (JPEG).

A Web site is conventionally a related collection of files and/or programs that includes a beginning file called a “home” page. From the home page, a visitor can access other files and applications, including hypertext, graphics, sounds, movies, as well as links to other files and applications at other Web sites. A large Web site may utilize a number of servers, which may or may not be different and which may or may not be geographically-dispersed. For example, the Web site of the International Business Machines Corporation (www.ibm.com) consists of thousands of Web pages and files spread out over multiple Web servers in locations world-wide.

A Web server (also referred to as an HTTP server) is a computer program that utilizes HTTP to serve files that form Web pages to requesting Web clients. Exemplary Web servers are International Business Machines Corporation's family of Lotus Domino® servers and the Apache server (available from www.apache.org). A Web client is a requesting program that also utilizes HTTP. A browser is an exemplary Web client for use in requesting Web pages and files from Web servers. A Web server waits for a Web client, such as a browser, to open a connection and to request a Web page. The Web server then sends a copy of the requested Web page to the Web client, closes the connection with the Web client, and waits for the next connection.

To ensure that browsers and Web servers can interoperate unambiguously, HTTP defines the format of requests (HTTP requests) sent from a browser to a Web server as well as the format of responses (HTTP responses) that a Web server returns to a browser. Exemplary browsers that can be utilized with the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects a particular hypertext link, a browser running on the user's client device reads and interprets an address, called a Uniform Resource Locator (URL) associated with the link, connects the browser with a Web server at that address, and makes a request (e.g., an HTTP request) for the file identified in the link. The Web server then sends the requested file to the client device which the browser interprets and renders within a display screen.

An intranet is a private computer network contained within an enterprise or home, and conventionally includes one or more devices, such as computers, printers, security systems, heating and air conditioning systems, audio/video systems, and various appliances. Conventionally, an intranet is isolated from the Internet by hardware and software referred to as a “firewall.” Only authorized persons are allowed entry from the Internet to an intranet through a firewall.

Uniform Resource Locators (URLs) Every device connected to the Internet or an intranet is identified by a unique IP (Internet Protocol) address, such as 198.77.305.55. A server typically has a static IP address that does not change. However, a home device that connects to the Internet via a modem is typically assigned an IP address by an Internet Service Provider (ISP) when the modem establishes communications with the ISP service. This IP address is typically unique for the particular session.

Each IP address may also be associated with a domain name, such as www.homedirector.com. The words, “www.homedirector.com”, when typed into a browser location field, are automatically translated to an IP address by a Domain Name System (DNS).

Each file on the Internet or an intranet has a unique address that defines its location. This address is referred to as a Uniform Resource Locator (URL) and has the following structure: protocol://computer:portnumber/unique_identifier. The “protocol” for accessing files on the Web is HTTP; therefore, Web URLs begin with “http://.” “Computer” is the name of the device that contains the file being requested. “Port number” designates a specific location on the device that is used to pass data in and out of the device.

By convention, the standard Web server port number is 80, and the standard secure Web server (Secure Sockets Layer-enabled) port number is 443. Other ports are, by convention, reserved for specific services. For example, the standard File Transfer Protocol (FTP) port number is 21, and the standard port number for Simple Mail Transfer Protocol (SMTP) is 25. However, various services may utilize different ports. For example, a Web server port may be designated as 775. If the Web server IP address is www.homedirector.com, a device accessing the Web server would connect to the Web server as follows: http://www.homedirector.com:775.

If a device on an intranet accepts connections from the Internet, and if a firewall is not protecting the port, a connection with the port can be made from anywhere on the Internet.

### Cookies

As is known to those skilled in the art, a cookie is an object used to store various types of information on a client. Conventionally, a cookie is a special text file that a server (e.g., a Web server) places on a client device (e.g., on the hard disk of a client device) so that the server can remember something about the user at a later time. A cookie can record a user's preferences when using a particular site, and can be used to authenticate a user.

As is known to those skilled in the art, each HTTP request for a Web page is generally independent of other requests. Accordingly, a server typically has no memory of a user's previous visits to a Web site or what Web pages the server has previously sent to a client. A cookie is a mechanism that allows a server to store its own file about a user on the user's own client device. The file is typically stored in a subdirectory of the browser directory (for example, as a subdirectory under the Netscape directory). A cookie subdirectory will typically contain a cookie file for each Web site a user has accessed that utilizes cookies. Cookies are described in detail in “Persistent Client State HTTP Cookies”, Netscape Communications Corporation, Mountain View, Calif., (www.netscape.com/newsref/std/cookie_spec.html), 1999, which is incorporated herein by reference in its entirety.

### Communicating With Private Network Devices

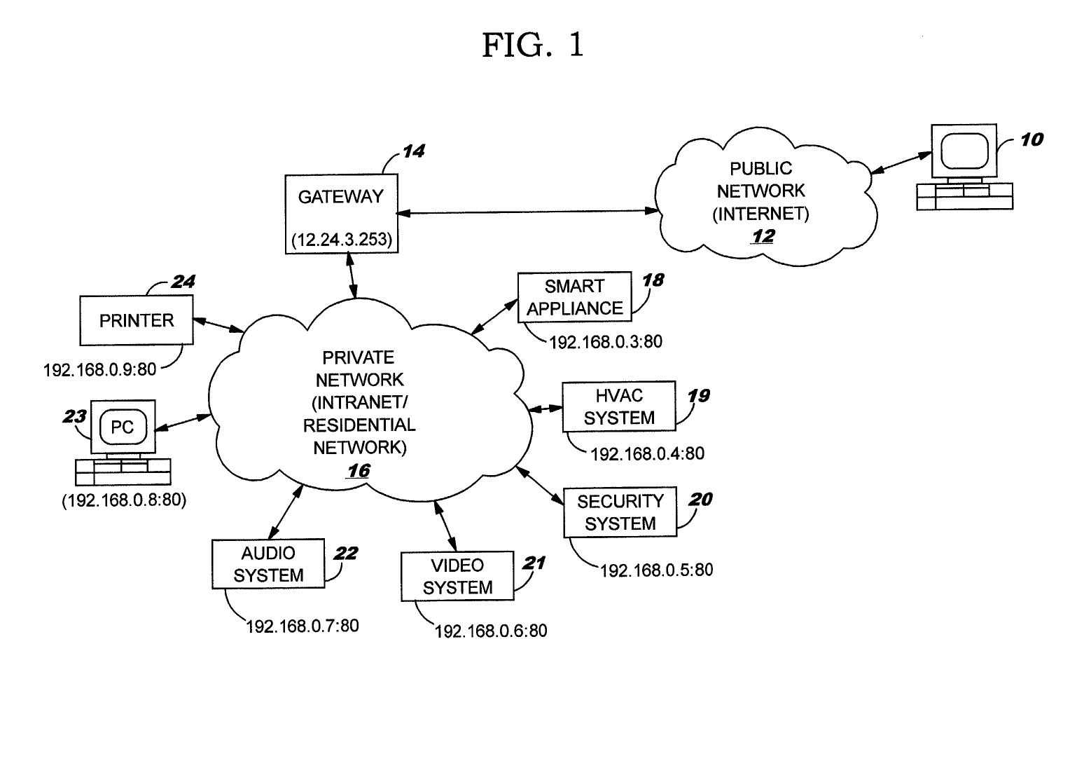

FIG. 1 is a schematic diagram of a private network having various devices connected thereto, and a client on a public network that is communicating with one or more of the devices on the private network via a gateway, according to embodiments of the present invention. The term “private network”, as used herein, includes, but is not limited to, home networks, proximity networks, networks in small businesses and commercial buildings, as well as intranets. The term “public network”, as used herein, includes, but is not limited to, the Internet, wide area networks, cellular radiotelephone networks and/or satellite radiotelephone networks.

In the illustrated embodiment, a client 10 is connected to public network 12, and a plurality of devices are connected to private network 16. The client 10 is preferably a browser executing on a device such as a personal computer. Other exemplary client devices include, but are not limited to, personal digital assistants (PDAs), hand-held computers, and cellular telephones. The client 10 may be connected to the public network via a wire connection and/or via a wireless connection.

In the illustrated embodiment, the following devices are connected to the private network 16: a gateway 14; a smart appliance 18; a heating, ventilating, and air conditioning (HVAC) system 19; a security system 20; a video system 21; an audio system 22; a personal computer (PC) 23; and a printer 24. These devices may be connected to the private network 16 via various technologies including, but not limited to, Ethernet, wireless, phone-line networking, and power-line networking. Each of the devices connected to the private network 16 includes an on-board Web server that allows a user to perform various configuration, trouble-shooting, and/or administrative functions with respect to the device. Each Web server has a respective IP address that is valid only on the private network 16. The IP addresses for these private network devices are not valid on the public network 12 because they are on a subnet not recognized on the public network 12, as would be understood by those skilled in the art.

The gateway 14 has an IP address that is valid on the public network 12 and is configured to communicate with the client 10 on the public network 12, as well as with devices on the private network 16. Preferably, the gateway 14 is configured to discover devices on the private network 16 by scanning a range of private network addresses to identify Web servers of devices that are listening on one or more selected ports. For example, the IP address range 192.168.nnn.nnn may be scanned to determine if open ports exist. As is understood by those of skill in the art of IP addresses, “nnn” can be 0 to 255 according to conventional IP addressing schemes. Each identified device Web server is then mapped to a respective port of the gateway 14, and stored in a routing list.

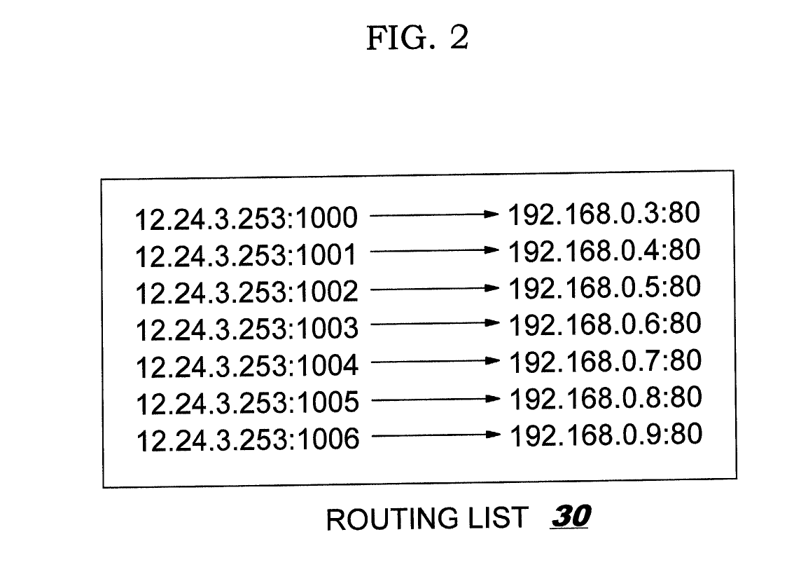

An exemplary routing list 30 is illustrated in FIG. 2. An address and open port of a Web server for each device connected to the private network 16 of FIG. 1 is mapped to a respective, different gateway port. For example, the Web server for the security system 20 (FIG. 1) has an IP address of 192.168.0.5 and is listening at port 80. As illustrated in FIG. 2, this Web server address (i.e., 192.168.0.5:80) is mapped to port 1002 of the gateway 14 (FIG. 1). Thus, as will be described below, a client request directed to the Web server of the security system 20 (FIG. 1) will be addressed to port 1002 of the gateway 14 (FIG. 1) using the IP address of the gateway 14 (i.e., the IP address that is valid on the public network 12).

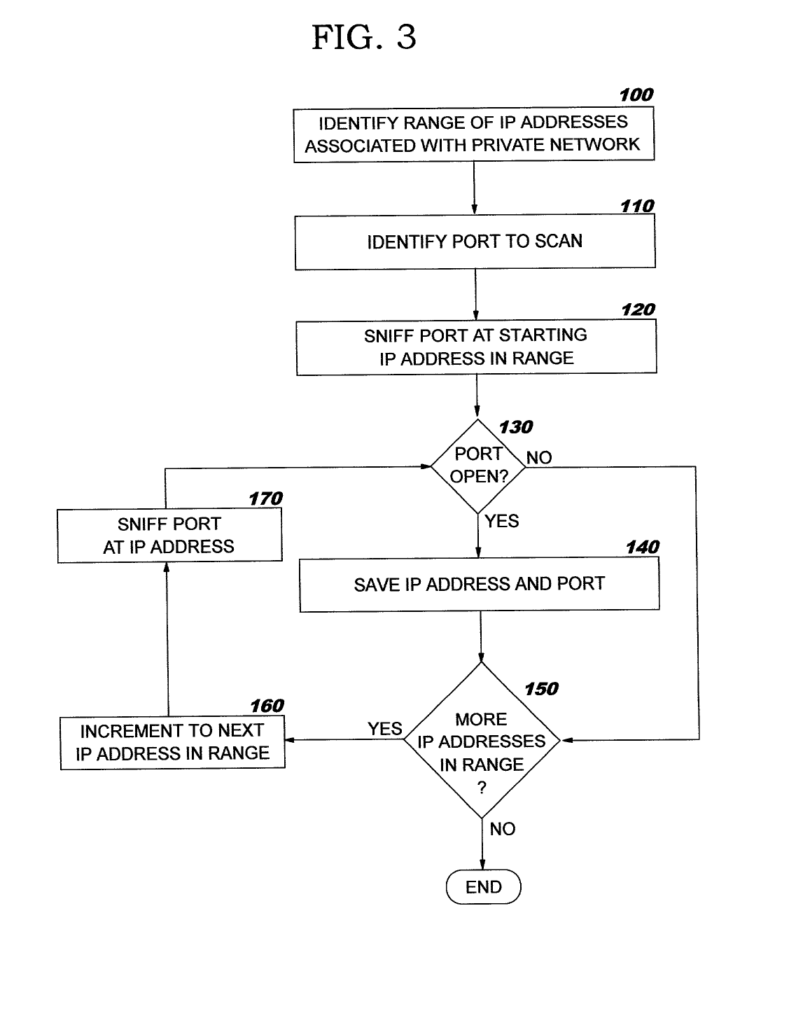

Referring now to FIG. 3, exemplary operations for discovering device Web servers on a private network, according to embodiments of the present invention, are illustrated. Some of the operations illustrated in FIG. 3 can be performed by programs such as “port sniffers” and “port scanners” which are well known to those of skill in the art. Initially, a range of IP addresses associated with a private network is identified (Block 100). A port to be scanned for each IP address in the range is identified (Block 110), and the starting IP address in the range is “sniffed” to determine if a device Web server is listening at the designated port, (i.e., a determination is made whether the designated port is open) (Block 120). If the port is open at the current IP address (Block 130), the IP address of the device Web server having the open port is saved (Block 140). If the port at the current IP address is not open (Block 130), a determination is made whether there are more IP addresses in the range (Block 150). If there are no more IP addresses in the range, operations terminate. If there are more IP addresses in the range (Block 150), the IP address is incremented to the next IP address in the range (Block 160) and this IP address is sniffed to determine if a device Web server is listening at the designated port (Block 170). Operations represented by Blocks 130-170 may continue until all IP addresses in a range have been processed.

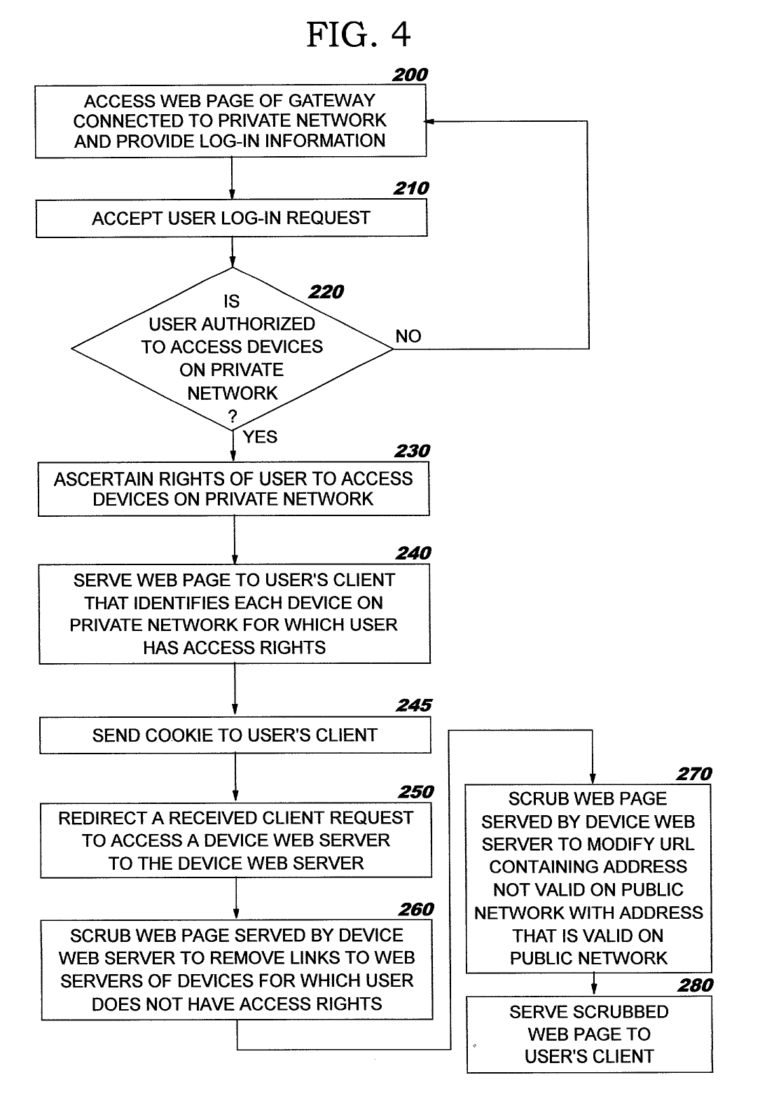

Referring now to FIG. 4, operations for accessing one or more devices on a private network via a client on a public network, according to embodiments of the present invention, are illustrated. A user, via a client on a public network, accesses a Web page of a gateway connected to a private network and receives a log-in prompt (Block 200). The gateway accepts the user's log-in request, which includes an identification of the user and, preferably, a password (Block 210). A determination is made whether the user is authorized to access any of the devices on the private network (Block 220). If the user is an authorized user, the gateway ascertains the rights of the user to access devices on the private network (Block 230). If the user is not an authorized user, operations may terminate. The user will be required to submit an authorized log-in request before operations can continue.

A Web page is served to the user's client that identifies each device on the private network for which the user has access rights (Block 240). According to alternative embodiments of the present invention, a secure cookie containing the user's log-in information and having a specified life span (e.g., 15 minutes after the last access) may be returned to the user's client with the served Web page (Block 245). The cookie may allow the user to access the Web server of any device that the user is authorized to access, but only for a specific time period. Each time the user accesses a device on the private network, the user's client sends the cookie to the gateway and the gateway determines whether the user is authorized to access the particular device. Upon expiration of the specified time period, the user would be required to log-in with the gateway. It is understood that embodiments of the present invention are not limited to the use of cookies. Alternatively, user log-in and/or session information may be encoded within a URL.

The Web page served to the user's client preferably includes a link (which may comprise text and/or graphics) to the Web server of each device on the private network for which the user has access rights. Each link includes a URL for the gateway that is valid on the public network and an identification of a gateway port that is mapped to the Web server of a respective device. Thus, when activated by the user, a link directs a client request to access a respective device Web server via a specific port of the gateway. For example, referring back to FIG. 2, a link to the Web server for the smart appliance 18 of FIG. 1 (having an IP address of 192.168.0.3:80) is directed to port 1000 of the gateway 14 of FIG. 1 (IP address 12.24.3.253).

Access rights may include certain rights with respect to a particular device. For example, if a user has administrator rights for a particular device, the user may be granted more rights with respect to the device than a user having normal access rights.

Referring back to FIG. 4, upon receiving a user request to access a device Web server in response to user activation of a link on the Web page, a gateway redirects the received client request to the respective device Web server (Block 250). The gateway scrubs a Web page served by a Web server in response to a client request to remove any links to Web servers of devices for which the user does not have access rights (Block 260), and to modify and/or “remap” a uniform resource locator (URL) containing an address not valid on the public network with an address that is valid on the public network (Block 270). For example, a link within a Web page served by a device Web server may contain a URL having an IP address within the domain of the private network which may not be valid on the public network. According to embodiments of the present invention, the gateway replaces the IP address that is valid only on the private network with the gateway IP address and an identification of a gateway port that is mapped to the replaced address. The gateway then serves the scrubbed Web page to the user client (Block 280).

Preferably, communications between a client on a public network and a gateway, according to embodiments of the present invention, utilize a secure transmission scheme, such as Secure Sockets Layer (SSL). SSL is a commonly-used protocol for managing the security of a message transmission on the Internet, and is well known to those of skill in the art.

Embodiments of the present invention may be utilized with various gateway standards (e.g., OSGi).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of accessing devices on a private network via a client on a public network, the method comprising the following steps performed by a gateway on the private network:
receiving a request from the client to access a Web server of a device on the private network, wherein the Web server has an address that is valid on the private network but is not valid on the public network;
redirecting the received client request to the Web server of the device on the private network;
scrubbing a Web page served by the Web server in response to the received client request, comprising replacing an address in the Web page that is not valid on the public network with an address that is valid on the public network; and
serving the scrubbed Web page to the client.

2. The method according to claim 1, further comprising the following steps performed by the gateway prior to receiving a request from the client to access a Web server of the device:
ascertaining rights of a user to access one or more devices on the private network; and
serving a Web page to the client that identifies each device on the private network for which the user has access rights, wherein the Web page includes a link to a Web server of each device on the private network for which the user has access rights.

3. The method according to claim 2, further comprising the step of accepting a user log-in request from the client prior to ascertaining rights of the user, wherein the user log-in request includes an identification of the user.

4. The method according to claim 2, wherein each link to a Web server includes a uniform resource locator (URL) for the gateway that is valid on the public network and an identification of a gateway port that is mapped to a respective Web server, and wherein each link is configured to send a request to a respective Web server via the gateway at an identified gateway port.

5. The method according to claim 1, wherein the scrubbing step comprises replacing an address in the Web page that is valid only on the private network with a URL for the gateway that is valid on the public network and an identification of a gateway port that is mapped to the replaced address.

6. The method according to claim 2, wherein the step of serving a Web page to the client comprises:
scanning a range of private network addresses to identify Web servers listening on one or more selected ports;
mapping each identified Web server to a respective gateway port; and
creating a Web page that contains a respective link to each gateway port for each device for which the user has access rights.

7. A method of accessing devices on a private network via a client on a public network, wherein each device includes a Web server having an address that is valid on the private network, but is not valid on the public network, the method comprising the following steps performed by a gateway on the private network:
ascertaining rights of a user to access one or more devices on the private network;
serving a Web page to the client that identifies each device on the private network for which the user has access rights, wherein the Web page includes a link to a Web server of each device on the private network for which the user has access rights;
receiving a request from the client to access a Web server of a device on the private network in response to user activation of a link on the Web page;
redirecting the received client request to the Web server;
scrubbing a Web page served by the Web server in response to the received client request, comprising removing links to Web servers of devices for which the user does not have access rights; and
serving the scrubbed Web page to the client.

8. The method according to claim 7, further comprising the step of accepting a user log-in request from the client prior to ascertaining rights of the user, wherein the user log-in request includes an identification of the user.

9. The method according to claim 7, wherein the scrubbing step further comprises replacing an address in the Web page that is not valid on the public network with an address that is valid on the public network.

10. The method according to claim 7, wherein each link to a Web server includes a uniform resource locator (URL) for the gateway that is valid on the public network and an identification of a gateway port that is mapped to a respective Web server, and wherein each link is configured to send a request to a respective Web server via the gateway at an identified gateway port.

11. The method according to claim 7, wherein the step of serving a Web page to the client comprises:
scanning a range of private network addresses to identify Web servers listening on one or more selected ports;
mapping each identified Web server to a respective gateway port; and
creating a Web page that contains a respective link to each gateway port for each device for which the user has access rights.

12. A method of accessing devices on a private network via a client on a public network, wherein each device includes a Web server having an address that is valid on the private network, but is not valid on the public network, the method comprising the following steps performed by a gateway on the private network:
ascertaining rights of a user to access one or more devices on the private network;
serving a Web page to the client that identifies each device on the private network for which the user has access rights, wherein the Web page includes a link to a Web server of each device on the private network for which the user has access rights, wherein each link to a Web server includes a uniform resource locator (URL) for the gateway that is valid on the public network and an identification of a gateway port that is mapped to a respective Web server, and wherein each link is configured to send a request to a respective Web server via the gateway at an identified gateway port;
receiving a request from the client to access a Web server of a device on the private network in response to user activation of a link on the Web page;
redirecting the received client request to the Web server;
scrubbing a Web page served by the Web server in response to the received client request, comprising:
removing links to Web servers of devices for which the user does not have access rights; and
replacing an address in the Web page that is not valid on the public network with an address that is valid on the public network; and
serving the scrubbed Web page to the client.

13. The method according to claim 12, further comprising the step of accepting a user log-in request from the client prior to ascertaining rights of the user, wherein the user log-in request includes an identification of the user.

14. The method according to claim 12, wherein the step of serving a Web page to the client comprises:
scanning a range of private network addresses to identify Web servers listening on one or more selected ports;
mapping each identified Web server to a respective gateway port; and
creating a Web page that contains a respective link to each gateway port for each device for which the user has access rights.

15. A gateway system that permits access to devices on a private network via a client on a public network, comprising:
means for receiving a request from the client to access a Web server of a device on the private network, wherein the Web server has an address that is valid on the private network but is not valid on the public network;
means for redirecting the received client request to the Web server;
means for scrubbing a Web page served by the Web server in response to the received client request, comprising means for replacing an address in the Web page that is not valid on the public network with an address that is valid on the public network; and
means for serving the scrubbed Web page to the client.

16. The gateway system according to claim 15, further comprising:
means for ascertaining rights of a user to access one or more devices on the private network; and
means for serving a Web page to the client that identifies each device on the private network for which the user has access rights, wherein the Web page includes a link to a Web server of each device on the private network for which the user has access rights.

17. The gateway system according to claim 16, further comprising means for accepting a user log-in request from the client, wherein the user log-in request includes an identification of the user.

18. The gateway system according to claim 16, wherein each link to a Web server includes a uniform resource locator (URL) for the gateway system that is valid on the public network and an identification of a gateway system port that is mapped to a respective Web server, and wherein each link is configured to send a request to a respective Web server via the gateway system at an identified gateway system port.

19. The gateway system according to claim 15, wherein the means for scrubbing a Web page comprises means for replacing an address in the Web page that is valid only on the private network with a URL for the gateway system that is valid on the public network and an identification of a gateway system port that is mapped to the replaced address.

20. The gateway system according to claim 16, wherein the means for serving a Web page to the client comprises:
means for scanning a range of private network addresses to identify Web servers listening on one or more selected ports;
means for mapping each identified Web server to a respective gateway system port; and
means for creating a Web page that contains a respective link to each gateway system port for each device for which the user has access rights.

21. A gateway system that permits access to devices on a private network via a client on a public network, wherein each device includes a Web server having an address that is valid on the private network, but is not valid on the public network, wherein the gateway system comprises:
means for ascertaining rights of a user to access one or more devices on the private network;
means for serving a Web page to the client that identifies each device on the private network for which the user has access rights, wherein the Web page includes a link to a Web server of each device on the private network for which the user has access rights;
means for receiving a request from the client to access a Web server of a device on the private network in response to user activation of a link on the Web page;
means for redirecting the received client request to the Web server;
means for scrubbing a Web page served by the Web server in response to the received client request, comprising means for removing links to Web servers of devices for which the user does not have access rights; and
means for serving the scrubbed Web page to the client.

22. The gateway system according to claim 21, further comprising means for accepting a user log-in request from the client, wherein the user log-in request includes an identification of the user.

23. The gateway system according to claim 21, wherein the means for scrubbing a Web page further comprises means for replacing an address in the Web page that is not valid on the public network with an address that is valid on the public network.

24. The gateway system according to claim 21, wherein each link to a Web server includes a uniform resource locator (URL) for the gateway system that is valid on the public network and an identification of a gateway system port that is mapped to a respective Web server, and wherein each link is configured to send a request to a respective Web server via the gateway system at an identified gateway system port.

25. The gateway system according to claim 21, wherein the means for serving a Web page to the client comprises:
means for scanning a range of private network addresses to identify Web servers listening on one or more selected ports;
means for mapping each identified Web server to a respective gateway system port; and
means for creating a Web page that contains a respective link to each gateway system port for each device for which the user has access rights.

26. A gateway system that permits access to devices on a private network via a client on a public network, wherein each device includes a Web server having an address that is valid on the private network, but is not valid on the public network, wherein the gateway system comprises:
means for ascertaining rights of a user to access one or more devices on the private network;
means for serving a Web page to the client that identifies each device on the private network for which the user has access rights, wherein the Web page includes a link to a Web server of each device on the private network for which the user has access rights, wherein each link to a Web server includes a uniform resource locator (URL) for the gateway system that is valid on the public network and an identification of a gateway system port that is mapped to a respective Web server, and wherein each link is configured to send a request to a respective Web server via the gateway system at an identified gateway system port;
means for receiving a request from the client to access a Web server of a device on the private network in response to user activation of a link on the Web page;
means for redirecting the received client request to the Web server;
means for scrubbing a Web page served by the Web server in response to the received client request, comprising:
means for removing links to Web servers of devices for which the user does not have access rights; and
means for replacing an address in the Web page that is not valid on the public network with an address that is valid on the public network; and
means for serving the scrubbed Web page to the client.

27. The gateway system according to claim 26, further comprising means for accepting a user log-in request from the client prior to ascertaining rights of the user, wherein the user log-in request includes an identification of the user.

28. The gateway system according to claim 26, wherein the means for serving a Web page to the client comprises:
means for scanning a range of private network addresses to identify Web servers listening on one or more selected ports;
means for mapping each identified Web server to a respective gateway system port; and
means for creating a Web page that contains a respective link to each gateway system port for each device for which the user has access rights.

29. A computer program product that permits access to devices on a private network via a client on a public network, the computer program product comprising a computer usable storage medium having computer readable program code embodied in the medium, the computer readable program code comprising:
computer readable program code that receives a request from the client to access a Web server of a device on the private network, wherein the Web server has an address that is valid on the private network but is not valid on the public network;
computer readable program code that redirects the received client request to the Web server;
computer readable program code that scrubs a Web page served by the Web server in response to the received client request, comprising computer readable program code that replaces an address in the Web page that is not valid on the public network with an address that is valid on the public network; and
computer readable program code that serves the scrubbed Web page to the client.

30. The computer program product according to claim 29, further comprising:
computer readable program code that ascertains rights of a user to access one or more devices on the private network; and
computer readable program code that serves a Web page to the client that identifies each device on the private network for which the user has access rights, wherein the Web page includes a link to a Web server of each device on the private network for which the user has access rights.

31. The computer program product according to claim 30, further comprising computer readable program code that accepts a user log-in request from the client, wherein the user log-in request includes an identification of the user.

32. The computer program product according to claim 30, wherein each link to a Web server includes a uniform resource locator (URL) for a gateway on the private network that is valid on the public network and an identification of a gateway port that is mapped to a respective Web server, and wherein each link is configured to send a request to a respective Web server via the gateway at an identified gateway port.

33. The computer program product according to claim 29, wherein the computer readable program code that scrubs a Web page comprises computer readable program code that replaces an address in the Web page that is valid only on the private network with a URL for a gateway on the private network that is valid on the public network and an identification of a gateway port that is mapped to the replaced address.

34. The computer program product according to claim 30, wherein the computer readable program code that serves a Web page to the client comprises:
computer readable program code that scans a range of private network addresses to identify Web servers listening on one or more selected ports;
computer readable program code that maps each identified Web server to a respective port of a gateway on the private network; and
computer readable program code that creates a Web page that contains a respective link to each gateway port for each device for which the user has access rights.

35. A computer program product that permits access to devices on a private network via a client on a public network, wherein each device includes a Web server having an address that is valid on the private network, but is not valid on the public network, the computer program product comprising a computer usable storage medium having computer readable program code embodied in the medium, the computer readable program code comprising:
computer readable program code that ascertains rights of a user to access one or more devices on the private network;
computer readable program code that serves a Web page to the client that identifies each device on the private network for which the user has access rights, wherein the Web page includes a link to a Web server of each device on the private network for which the user has access rights;
computer readable program code that receives a request from the client to access a Web server of a device on the private network in response to user activation of a link on the Web page;
computer readable program code that redirects the received client request to the Web server;
computer readable program code that scrubs a Web page served by the Web server in response to the received client request, comprising computer readable program code that removes links to Web servers of devices for which the user does not have access rights; and
computer readable program code that serves the scrubbed Web page to the client.

36. The computer program product according to claim 35, further comprising computer readable program code that accepts a user log-in request from the client, wherein the user log-in request includes an identification of the user.

37. The computer program product according to claim 35, wherein the computer readable program code that scrubs a Web page further comprises computer readable program code that replaces an address in the Web page that is not valid on the public network with an address that is valid on the public network.

38. The computer program product according to claim 35, wherein each link to a Web server includes a uniform resource locator (URL) for a gateway on the private network that is valid on the public network and an identification of a gateway port that is mapped to a respective Web server, and wherein each link is configured to send a request to a respective Web server via the gateway at an identified gateway port.

39. The computer program product according to claim 35 wherein the computer readable program code that serves a Web page to the client comprises:
computer readable program code that scans a range of private network addresses to identify Web servers listening on one or more selected ports;
computer readable program code that maps each identified Web server to a respective port of a gateway on the private network; and
computer readable program code that creates a Web page that contains a respective link to each gateway port for each device for which the user has access rights.

40. A computer program product that permits access to devices on a private network via a client on a public network, wherein each device includes a Web server having an address that is valid on the private network, but is not valid on the public network, the computer program product comprising a computer usable storage medium having computer readable program code embodied in the medium, the computer readable program code comprising:
computer readable program code that ascertains rights of a user to access one or more devices on the private network;
computer readable program code that serves a Web page to the client that identifies each device on the private network for which the user has access rights, wherein the Web page includes a link to a Web server of each device on the private network for which the user has access rights, wherein each link to a Web server includes a uniform resource locator (URL) for a gateway on the private network that is valid on the public network and an identification of a gateway port that is mapped to a respective Web server, and wherein each link is configured to send a request to a respective Web server via the gateway system at an identified gateway port;
computer readable program code that receives a request from the client to access a Web server of a device on the private network in response to user activation of a link on the Web page;
computer readable program code that redirects the received client request to the Web server;
computer readable program code that scrubs a Web page served by the Web server in response to the received client request, comprising:
computer readable program code that removes links to Web servers of devices for which the user does not have access rights; and
computer readable program code that replaces an address in the Web page that is not valid on the public network with an address that is valid on the public network; and
computer readable program code that serves the scrubbed Web page to the client.

41. The computer program product according to claim 40, further comprising computer readable program code that accepts a user log-in request from the client prior to ascertaining rights of the user, wherein the user log-in request includes an identification of the user.

42. The computer program product according to claim 40, wherein the computer readable program code that serves a Web page to the client comprises:
computer readable program code that scans a range of private network addresses to identify Web servers listening on one or more selected ports;
computer readable program code that maps each identified Web server to a respective gateway port; and
computer readable program code that creates a Web page that contains a respective link to each gateway port for each device for which the user has access rights.
